(19) United States
(12) Patent Application Publication
(10) Pub. No.: US 2006/0237120 A1
(43) Pub. Date: Oct. 26, 2006

(54) Method for the manufacture of corrugated board

(75) Inventors: Jorma Mattila, Kangasala (FI); Hannu Suksi, Lohja AS (FI); Kirsi Nissinen, Vilppula (FI)

Correspondence Address: BIRCH STEWART KOLASCH & BIRCH, PO BOX 747, FALLS CHURCH, VA, 22040-0747, US

(73) Assignee: Avenira Oy, Julkujarvi (FI)

(21) Appl. No.: 10/546,981

(22) PCT Filed: Feb. 23, 2004
(86) PCT No.: PCT/FI04/00077

§ 371 Date: Jun. 1, 2006

(30) Foreign Application Priority Data
Feb. 26, 2003 (FI) 20030288

(51) Int. Cl. B31F 1/28

(52) U.S. Cl. 156/205

(57) ABSTRACT

The present invention is directed to a method for the manufacture of corrugated board and to a method for gluing a fluting medium to a liner by means of hot-melt adhesives using curtain coating technique. By means of this method it is possible to manufacture corrugated board consisting of one or more corrugated layers of board and one or more layers of liner, joined to each other.

### TECHNICAL FIELD

The present invention is directed to a method for the manufacture of corrugated board and to a method for gluing a fluting medium to a liner by means of hot-melt adhesives using curtain coating technique. By means of this method it is possible to manufacture corrugated board consisting of one or more fluting layers and one or more layers of liner, joined to each other.

### BACKGROUND ART

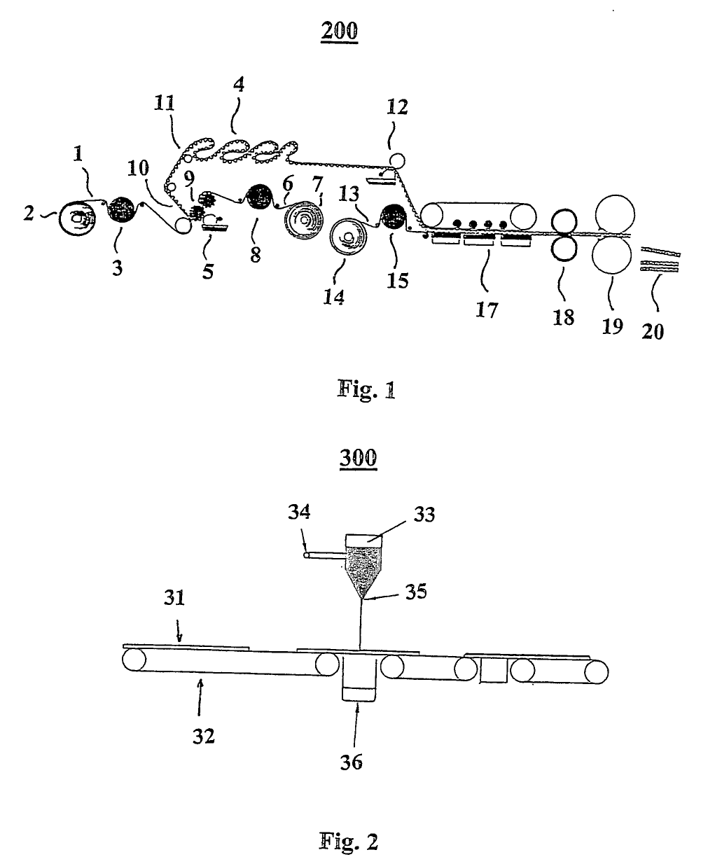

Corrugated board is traditionally manufactured on a production line using reels of board and water-based glue as starting material and converting them into sheets of corrugated board. FIG. 1 shows a simplified graphical representation 200 of a traditional corrugated board production line.

In FIG. 1 a liner 1 is passed from a reel 2 to a liner preheater 3 and from there further to a gluing apparatus 5, after which the liner 1 is joined with a fluting medium 6 coming from a reel 7 via a fluting medium preheater 8 to a corrugator 9 and to the gluing apparatus 5. The single-faced corrugated board 10 thus obtained advances via a pull-up conveyor 11, bridge 4 and preheaters to a gluing unit 12. A liner 13 from a reel 14 is passed via a preheater 15 to a hot plate 17, where it is joined with the single-faced corrugated board 10. The double-faced corrugated board is passed further from the hot plate 17 to a slitter-scorer 18, cut-off knife 19 and receiving device 20.

The fluting medium is glued to the liner in a gluing apparatus, where the glue is applied to the tips of the flutes of the fluting medium. In a traditional gluing apparatus a glue roll takes glue from a blue box and applies the glue as a uniform layer onto the flute tips of the fluting medium, at the same time pressing the glue roll gently against the flute tips. After the application of glue the liner is joined with the fluting medium. More developed gluing units are also known from prior art, which units, however, have mainly the same basic principle according to which aqueous glue is applied to one side of the flute tips. After the application of glue, the board webs are passed onto a hot plate, where the corrugated board takes its final form, which is stiff in all directions. The main task of the hot plate i.e. the heating part is to provide the corrugated board with so much additional heat that a glue joint is formed, which is strong enough to withstand the next production steps in the corrugated board machine. The hot plate also serves to remove from the corrugated board excess moisture caused by the glue and possible moisturizing steam of the fluting medium.

The glue used in a corrugated board machine is more often than not a starch-based glue containing a great amount of water, starch, e.g. cornstarch, and alkali such as sodium hydroxide. Borax or boric acid may additionally be used as a cutting chemical of lye swelling and for controlling the viscosity of the glue, and other additives such as polyvinyl alcohol may be used for modification and improvement of gluing properties.

The glue is prepared in a separate glue preparation room normally situated in close proximity to the corrugated board machine. The glue preparation room comprises an apparatus for manufacturing glue and/or for mixing glue and pumping it to the corrugated board machine.

The prior art manufacturing methods of corrugated board using aqueous glues have involved many problems. If the heat content of the board is not sufficient or if too much glue has been applied, the joint becomes separated directly after the gluing step and the rate of the machine has to be decreased. Too much glue may also cause quality defects in the finished corrugated board. If the glued joint has too large shoulders, they pull the thin liner downwards as they become dry, which leads to a so-called washboarding phenomenon in which the surface of the corrugated board resembles a washboard. Another possible defect, especially in thin liners, is liner warping between the flute tips.

U.S. Pat. No. 3,644,159 discloses a method and a device for the manufacture of corrugated board, in which method a thermoplastic coating has been applied to one or more liners/fluting media, which coating may be molten to reach a liquid state by means of heat, especially by means of hot-air nozzles blowing air having a temperature of 400-600° C. to the surfaces of the liner and the fluting medium as they are joined together by means of press rolls. An electrical furnace may also be optionally used in this connection as an additional heater.

U.S. Pat. No. 3,811,987 presents a device for the manufacture of water-resistant corrugated board. The liner and fluting medium surfaces to which a thermoplastic coating has been applied in advance are heated by means of a flame, preferably an acetylene-oxygen flame, whereby the thermoplastic coating melts and the surfaces are joined together by means of press rolls.

A curtain coating apparatus and method are commonly used in extrusion coating processes, in which a thermoplastic polymer is applied to paper or other surfaces or substrates. By means of the curtain coating apparatus it is possible to form a continuous film of coating, which, as a curtain, either falls due to gravity or is moved by means of pressure between slice lips onto a web running underneath. A molten material or a solvent-based or aqueous composition may be used as the coating. The coating can be applied, by means of pressure, to the moving web either from above the web or from below it as a so-called fountain version. Excess coating falling over the web edges can be collected in a vessel below the apparatus and be recirculated to feeding. FIG. 2 shows schematically a typical curtain coating apparatus.

In FIG. 2 a sheet 31 (a web can also be used instead of a sheet) is brought by means of a conveyor 32 to a curtain coating device 300. Molten/liquid coating material is fed to a feeding tank 33 of the curtain coating device through a feed channel 34. The coating material is allowed or forced by means of pressure to fall through a slice opening 35 as a continuous curtain or film of the width of the sheet 31 onto the surface of the sheet 31. Possible excess coating falls into a collecting vessel 36, from where it is returned to the feeding tank 33.

The dry solids content of aqueous dispersion type adhesives is normally 18-30% by weight, 65% by weight at most. The water has to be evaporated off the finished product, which often has a negative effect on fiber properties. The evaporation of water also requires a great amount of energy and a long drying unit is necessary in order to reach the desired water content, which in an end product is usually 8% by weight of water at most, When evaporating moisture off dense materials by means of the hot plate, the pressure of the water vapour may separate the layers from each other. Problems relating to sufficient smoothness and the quality of printing also arise. Other problems often related to corrugated board are the so-called washboarding phenomenon as well as warping, which leads to further problems in further processing and printing.

When using aqueous dispersion adhesives it is not possible to apply very small amounts of glue. The amount of glue used is normally at least 2 g/m², often, when applied to the flute tips, the amount of glue applied is too great and controlling the glue layer causes problems. Problems have occurred in the manufacture of small-fluted corrugated board especially in connection with gluing devices, and particularly in micro-flute products the use of a starch-based adhesive is problematic.

Also, starch-based adhesives require the use of additives due to their poor water endurance. The additives as well as the strong alkalis used in the glue are often detrimental chemicals requiring appropriate protective measures. Further, the standardization of glue as well as keeping it constant during the process causes problems related to reproducibility, and the present processes tend to have big tolerances because of this. When, in a traditional device, the glue is transferred from the roll to a flute tip, the glue has been found to splash, and the behaviour of the glue is attempted to be controlled by varying the rates of the glue roll relative to the webs. Controlling the process is often difficult and the production line is run either too wet or too dry, meaning that the product will not behave as desired in the process.

Based on the foregoing it can be seen that there is an obvious need for an improved method for the manufacture of corrugated board and especially for gluing a fluting medium to a liner.

### OBJECT OF INVENTION

An object of the invention is to a method for the manufacture of corrugated board by means of hot-melt adhesives using curtain coating technique.

A further object of the invention is a method for gluing a fluting medium to a liner by means of hot-melt adhesives using curtain coating technique.

The characteristic features of the methods according to the invention are presented in the claims.

### SUMMARY OF INVENTION

It has been found that the defects and problems of the methods for manufacturing corrugated board according to the invention can be avoided or at least substantially reduced by using a method in which the gluing of fluting medium and liner webs is carried out by means of hot-melt adhesives using curtain coating technique. The curtain coating is performed on a smooth liner web directly prior to joining the liner and fluting medium webs together. The hot-melt adhesive used in the curtain coating can be manufactured by means of any prior art method, e.g. by using extrusion technique and advantageously in close proximity to the corrugated board machine. This way the traditionally used drying unit i.e. the hot plate and the glue preparation room are no longer needed, thereby significantly reducing the length of the corrugated board machine.

### DETAILED DESCRIPTION OF INVENTION

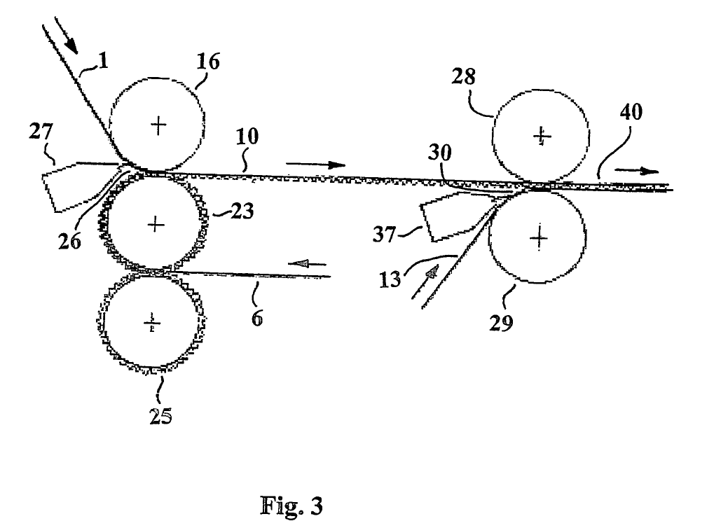

In the method according to the invention the gluing of liner and fluting medium webs is carried out by means of a curtain coating device situated close to a press gap i.e. roll nip, where the fluting medium and liner are joined to each other. Curtain coating is performed on the inner surface of the liner. The method according to the invention is illustrated in the accompanying FIG. 3.

In FIG. 3 a liner 1 is passed to a press roll 16, whereto a fluting medium 6 is also passed via an upper corrugator roll 23 and a lower corrugator roll 25, and a uniform layer of hot-melt adhesive is applied to the liner 1 near a press gap 26 by means of a curtain coating unit 27. The liner 1 and the fluting medium 6 are then joined together and a single-faced corrugated board web 10 is obtained, which web is passed to press rolls 28 and 29, whereto a liner 13 is also passed, to which liner a uniform layer of hot-melt adhesive is applied by means of a curtain coating unit 37 situated near a press gap 30, and the liner 13 and the single-faced corrugated board 10 are joined together, whereby a double-faced corrugated board web 40 is obtained. When it is desired to manufacture multiple-wall corrugated board, there may be several successive gluing and corrugating units. What is more, there are no limitations as to the extent to which the flute height and width can be varied according to the end product and what is needed.

In the method according to the invention curtain coating technique and curtain coating devices known from prior art may be used. The hot-melt adhesive is prepared to a molten state, e.g. in the same way as in extrusion technique, and or by using some other prior art technique, advantageously in close proximity to the curtain coating device. The molten glue is passed to a slice lip of the curtain coating device, from where it is passed as a homogeneous, uniform curtain onto the surface of the liner web. The amount of glue may vary between 1 and 50 g/m², preferably being 3-6 g/m². The amount of glue is dependent on the stiffness and level of protection provided by means of the glue film.

Preferably, hot-melt adhesives containing at least 90% by weight of glue are used. The hot-melt adhesive is molten or brought into a liquid state at a temperature of 70-190° C. and it is then pumped into a glue container of the curtain coating device, from which container a glue film is applied in the form of a curtain as a smooth, uniform film or as foam to the liner surface near the press gap by using a nozzle situated at the slice opening providing a homogeneous curtain-forming glue film from the slice lip across the liner web. The distance of the curtain coating device from the press gap is advantageously 1-100 cm. The width of the slice opening is 0.05-2 mm, preferably 0.2-0.3 mm and the distance between the slice lip and the web is 2-100 mm, preferably 5-10 mm.

Directly after the second gluing the glued corrugated board continues to advance as a stiff plane. The curtain can be provided from above the web as well as from below it.

Suitable adhesives are all generally known hot-melt adhesives and adhesive compositions. The hot-melt adhesive compositions typically comprise at least one thermoplastic polymer, at least one softener and at least one glue resin component.

The hot-melt adhesives usually contain 50% by weight of thermoplastic polymer at most, 40% by weight of plasticizer at most and 70% by weight of glue resin component at most. In addition, wax is used in some hot-melt adhesives, and the adhesives may also contain other additives depending on the intended use. The hot-melt adhesive may also contain at least one starch-based transglycerolisation glue i.e. TG glue or a combination of the above-mentioned adhesives.

The method according to the invention has several advantages over prior art methods. In the method of the invention glue containing practically no moisture at all can be used, thereby avoiding all problems due to water, moisture and the drying of corrugated board. As a consequence, printing of corrugated board is remarkably easier, because the printing surfaces are smooth and the print quality is better. By means of the method according to the invention it is also possible to significantly diminish the so-called washboarding phenomenon, thereby further significantly improving printability.

With the method according to the invention it is possible to manufacture corrugated board using linerboards having a much lower grammage than prior art liners. The material now typically used has a grammage of 160-180 g /m², whereas by means of the technique of the invention a value of 40 g/m² (grammage of a single liner), for printing most preferably of 110-135 g/m² can be reached.

Corrugated board manufactured by means of the method according to the invention is much more resistant to water and moisture, since the corrugated board includes one or more layers containing thermoplastic polymer. That being the case the glued joint also serves as an insulation layer against water, water vapour and grease. Corrugated board manufactured by means of the method according to the invention has excellent printability, the product can be easily processed further and its straightness is easy to control. Further processing can be carried out immediately and the product does not require equalizing or equilibration time like products manufactured by means of traditional aqueous dispersion. In the method according to the invention the layers do not become separated from each other and the vapour pressure does not get to affect the product. This provides more uniform glue adhesion in both cross- and longitudinal direction. It is now also possible to use materials in the manufacture of corrugated board that are heat-sensitive, such as laminates, that comprise polyethylene in between or on the outer surface, or other thermoplastic plastics having a low melting point. Thanks to the rapid gluing process and the fact that there is no longer a need for control, a significantly smaller amount of waste is produced. Since it is not necessary to use water in the method of the invention, no hot plate, drying section or glue preparation room is needed. Due to improved gluing control, the running speed of the web can be at least doubled, to a value over 500 m/min.

1. Method for the manufacture of corrugated board, characterized by carrying out the gluing of a liner/liners to a fluting medium by means of a hot-melt adhesive using curtain coating technique.

2. Method according to claim 1, characterized by applying the hot-melt adhesive with a curtain coating unit situated near a press gap, the distance between the curtain coating unit and the press gap being preferably 1-100 cm.

3. Method according to claim 1 or 2, characterized by applying the hot-melt adhesive to the liner and then joining the liner and the fluting medium together.

4. Method according to any one of claims 1-3, characterized by applying the hot-melt adhesive to an inner surface of the liner as a uniform film or foam.

5. Method according to any one of claims 1-4, characterized in that the hot-melt adhesive comprises at least one thermoplastic polymer, at least one softener and at least one glue resin component, or the hot-melt adhesive comprises at least one starch-based transglycerolisation glue, or a combination thereof.

6. Method for gluing a fluting medium to a liner, characterized by carrying out the gluing of the liner/liners to the fluting medium by means of a hot-melt adhesive using curtain coating technique.

7. Method according to claim 6, characterized by applying the hot-melt adhesive with a curtain coating unit situated near a press gap, the distance between the curtain coating unit and the press gap being advantageously 1-100 cm.

8. Method according to claim 6 or 7, characterized by applying the hot-melt adhesive to the liner and then joining the liner and the fluting medium together.

9. Method according to any one of claims 6-8, characterized by applying the hot-melt adhesive to an inner surface of the liner as a uniform film or foam.

10. Method according to any one of claims 6-9, characterized in that the hot-melt adhesive comprises at least one thermoplastic polymer, at least one plasticizer and at least one glue resin component, or the hot-melt adhesive comprises at least one starch-based transglycerolisation glue, or a combination thereof.
